(19) United States
(12) Patent Application Publication
(10) Pub. No.: US 2010/0288267 A1
(43) Pub. Date: Nov. 18, 2010

(54) Solar Water Heating System and Components Thereof

(76) Inventor: Bradley Michael Kanack, Gettysburg, PA (US)

Correspondence Address: Bradley Michael Kanack, 865 Good Intent Road, Gettysburg, PA, 17325, US

(21) Appl. No.: 12/465,820

(22) Filed: May 14, 2009

(51) Int. Cl. F24J 2/04; B23P 15/26

(52) U.S. Cl. 126/640; 29/890.033

(57) ABSTRACT

A solar water heating system is disclosed. The system consists of three main parts, the solar water heating apparatus and an intelligent system controller and an optional auxiliary hot water holding tank. The system is intended to be easily retrofitted to existing water heating device to provide supplementary hot water as the weather conditions allow and to expressly become inactive when weather conditions do not provide for water heating. The system is designed to allow for freezing temperatures without hindering the primary water heating device. In addition, if the solar water heating apparatus fails, the primary water heating device will not be effected. Finally, when weather conditions are favorable, the system, with the auxiliary tank, provides adequate quantity of hot water for the user.

### FIELD OF THE INVENTION

The invention relates to water heating by the absorption of solar radiation and the method and system to improve practically with minimal user intervention.

### BACKGROUND OF THE INVENTION

Solar heating of water is well known in prior art. Most solar water heating systems designed for business or residential use are supplementary, being that they provide heated water only when the weather conditions allow. Thus, these systems rely on a primary device to be able to provide hot water at any given time. Of these, there are two primary types of solar water heating devices, one which uses a heat exchanger and the other which is directly in series with the cold water supply. In the first type of system, the solar radiation is gathered utilizing a fluid path which is exposed to the sun, this fluid is circulated, passively or actively, to a heat exchanger which then imparts heat to water thus providing the desired hot water. As such, the system must employ a fluid path which is designed never to be exposed to freezing temperatures or a heat transmitting fluid which can withstand all temperature extremes. The latter is most common by using something as simple as a solution of water and ethylene glycol. Drawbacks of this system are mainly the possibility of contamination of the primary water system through leaks and the cost, space and efficiency of the heat exchanger.

The second type of system is directly inline with the cold water supply. Thus when the fluid path is exposed to solar radiation, and is hot, the water is heated by the said path and thus does not require the primary device to heat the water, saving energy. Although this system is very simple, there are two main drawbacks. If the system fails, the primary supply of hot water to the user is compromised and when weather conditions are not favorable the system can result in heat loss. This heat loss in cold temperatures can result in the primary system having to add energy to heat water to the desired temperature. Moreover, the panel can not withstand freezing temperatures since it uses pure water. These drawbacks result in the requirement of user interaction to take the system off line and drain it when there is the possibility of adverse weather.

Accordingly, the need exists for a solar water heating system which can withstand freezing temperatures, can directly use primary water supply and provide large quantities of hot water in favorable weather conditions. The need for minimal user interaction is also desired whereas the system can directly go on and off line as the weather provides. Finally, the system should not interfere with the primary water heating device even when it fails.

### SUMMARY OF THE INVENTION

This invention provides for a solar water heating system which provides for hot water needs of the users under favorable weather conditions with minimal user intervention. The system is designed to be retrofitted to an existing primary water heating device. The three main parts of the water system are a low cost solar water heating apparatus, an intelligent system controller and an optional auxiliary hot water holding tank. The solar water heating apparatus is expressly designed to interact with the system by connection to the intelligent system controller. The solar water heating apparatus is designed specifically to withstand the expansion of water as it freezes without damage. The materials used for the construction, stretch to allow for the phase change and expansion of water from liquid to solid. Moreover, the apparatus is design to withstand an over temperature condition, when water changes from liquid to steam by relieving pressure via an integral pressure relief valve. The apparatus is designed to allow water storage and has a principal solar radiation absorbing surface. As the solar radiation is absorbed by this primary surface, thus its temperature increases, and thus heat is transferred to the volume of water stored within the apparatus. When the said water reaches a desired temperature determined by the system controller, a pump is activated, displacing the hot water within the solar water heating apparatus with colder water within the closed loop of the water heating system. The input to solar water heating apparatus is controlled by a pump and with an integral water shut off, thus water only flows when the pump is activated. The water output path has a common water check valve. The combination of the pump and check valve result in control of the water flow in the advent of system failure or a leak thus protecting the primary water system from failure. The closed loop of the water heating system is displaced by raising the temperature of the water in the primary water heating device above the normal threshold temperature whereas it normally stops heating water. The cycle of heating water in the solar water heating apparatus and re-circulating to maintain or increase the water temperature in the primary water heating device continues as long as there is excess heat in the solar water heating apparatus or until the maximum desired water temperature within the primary device is reached. As the users of the system withdraw hot water from the system, the desired temperature is obtained by intermixing the hot water with cold water at the point of use. This use thereby results in a drop of water temperature in the primary water heating device by the addition of cold fresh water. At this point, the solar water heating apparatus in combination with the system controller again heats the water in the primary water heating device, provided that the solar water heating apparatus has excessive heat. In addition, an optional auxiliary water tank can also placed inline with the cold water source of the primary water heating device. This auxiliary water tank provides for additional hot water storage above the storage of the primary water heating device. With direct control from the system controller, the auxiliary water tank may be brought online depending on the algorithm of the system controller. The auxiliary water tank is expressly designed to vary the internal volume of water which it holds. When the system controller is using the solar water heating apparatus to increase the temperature in the primary device tank, the auxiliary tank is in an standby mode whereby the internal volume of water is held at a minimum. Cold water supply to the primary system flows through the auxiliary tank to the primary tank as hot water is used. The algorithm of the controller will take into account, various physical parameters such as the current temperature of the water in the primary water heating device, the temperature of the solar water heating apparatus, the time of day, the season of the year and other environmental factors. The system controller also may included a plurality of status information, alarms and the ability to interconnect into a variety of communication systems to provide status information to users or maintenance personnel. By an algorithm, the system controller will determine the likelihood of providing additional hot water beyond the volume of the primary water heating device. When it is determined that the solar water heating apparatus is likely to supply additional hot water, the system controller will change the volume of the water internal to the auxiliary tank. The auxiliary tank will increase the internal volume of water by displacement of an equal volume of material thus drawing in more cold water from the cold water supply. The displacement will be drawn out of an internal expandable bladder within the larger auxiliary tank. After drawing in more fresh cold water from the water supply, the system controller, depending upon its algorithm, may partially refill the internal bladder, to increase the pressure within the hot water line. This effect will be to insure that the water volume used by the users, during water heating cycles will draw from the current volume within the system and not the cold water supply. While the current hot water volume is re-circulated within the system by heating from the solar water heating apparatus. As the pressure drops near to the cold water pressure from usage, the volume of the bladder could be controlled by the system controller by adding volume to the bladder. This would continue under the controller until the maximum volume of the bladder is reached or the high threshold temperature is again reached. Thus, the volume of the bladder is again reduced to draw in more cold water. The system controller algorithm would then re-circulate the current volume of the additional water and the already hot water in the primary system in combination with the extra heat of the solar water heating apparatus to continue heating the new volume to the maximum temperature. Sequentially, this cycle continues until the system controller determines the maximum temperature and volume of the system has been reached or it is determined that the environmental factors monitored by the system controller have resulted in a case where the likelihood of increasing the temperature of the water in the system has passed. At any point in time, the users may withdraw hot water from the system, thus displacing the hot water used with volume from the expanding bladder. Finally, as the environmental conditions and hot water usage determine, the total volume of the auxiliary tank may become exhausted and the tank again becomes inactive. The cycle of heating, recycling and varying the volume of the auxiliary tank would continue, depending upon the status of the solar water heating apparatus. When environmental conditions are not favorable for the solar heating of water, the primary water heating device is used as normal.

### OBJECTS OF THE INVENTION

One of the primary objects of the invention is to provide for a low maintenance solar heating apparatus which is expressly designed to allow for continuous cycles of freezing and thawing without damage or maintenance. This object is monitored remotely from a system controller. This solar water heating apparatus also allows for safe over heating condition of water turning into steam.

Another primary object of the invention is to provide additional volume of hot water storage when the conditions are favorable to reduce the demand presented to the primary water heating device and to adaptively control the volume of the additional water supply depending on intelligent control of a system controller.

Another primary object of the invention is to provide a system which requires a minimum of user interaction and determines through an algorithm when the primary water heating device can be supplemented.

Another primary object of the invention is to provide for a fail-safe condition whereby if the solar water heating system fails, the primary water heating device can continue to operate uninterrupted.

Another primary object of the invention is to provide status, alarm and maintenance information via a front panel or by interconnection to a communications network.

Other further objects of the present invention will be come apparent as studied by those skilled in the art.

### BRIEF DESCRIPTION OF THE DRAWINGS

FIG. 1 is a overall perspective view of the solar water heating system retrofitted to an existing primary water heating device.

FIG. 2 is the top view of the solar water heating apparatus which is one primary parts of the solar water heating system.

FIG. 3 is a full sectional view of FIG. 2 section G-G′ showing internal detail of the solar water heating apparatus.

FIG. 4 is a full sectional view of FIG. 2 section H-H′ showing the internal detail of the solar water heating apparatus.

FIG. 5 is a full sectional view of FIG. 3 section J-J′ showing the internal detail of the solar water heating apparatus.

FIG. 6 is a full sectional view of the auxiliary tank and associated operational parts which is a primary part of the solar water heating system.

### DESCRIPTION OF THE PREFERRED EMBODIMENTS

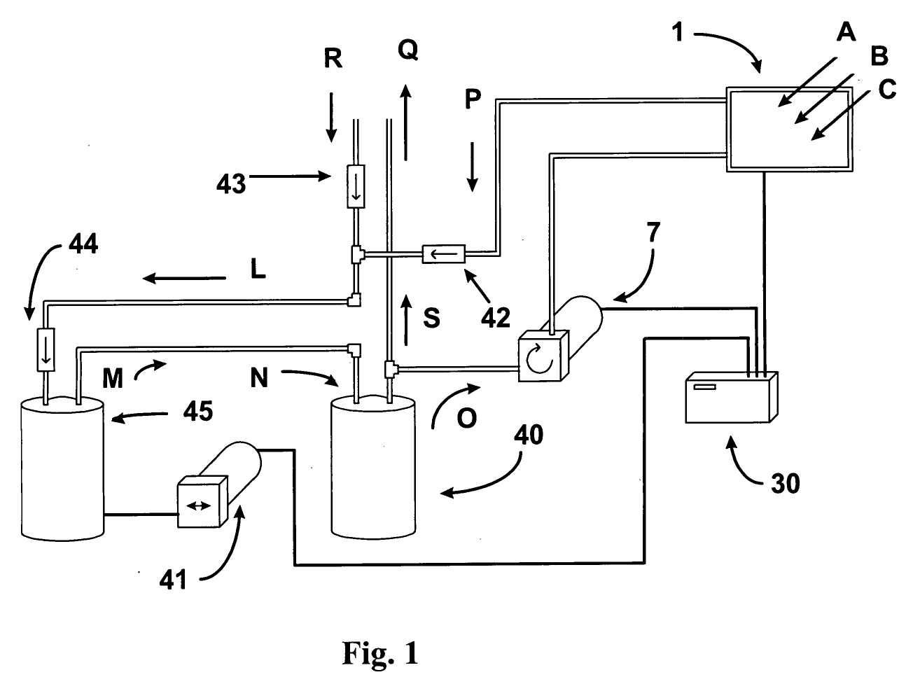

Referring to the drawings, wherein like reference numerals represent like parts throughout the figures of the present invention of a solar water heating system, reference numeral 1 is directed to a solar water heating apparatus (FIG. 1) according to a preferred embodiment of this invention. Reference numeral 30 is directed to a intelligent system controller. Reference numeral 7 is directed to a water pump. Reference numeral 40 is to a primary water heating device. Reference numerals 42, 43 and 44 are directed to common water check valves. Reference numeral 41 is directed to a fluid or air pump. Reference numeral 45 is directed to a auxiliary water tank.

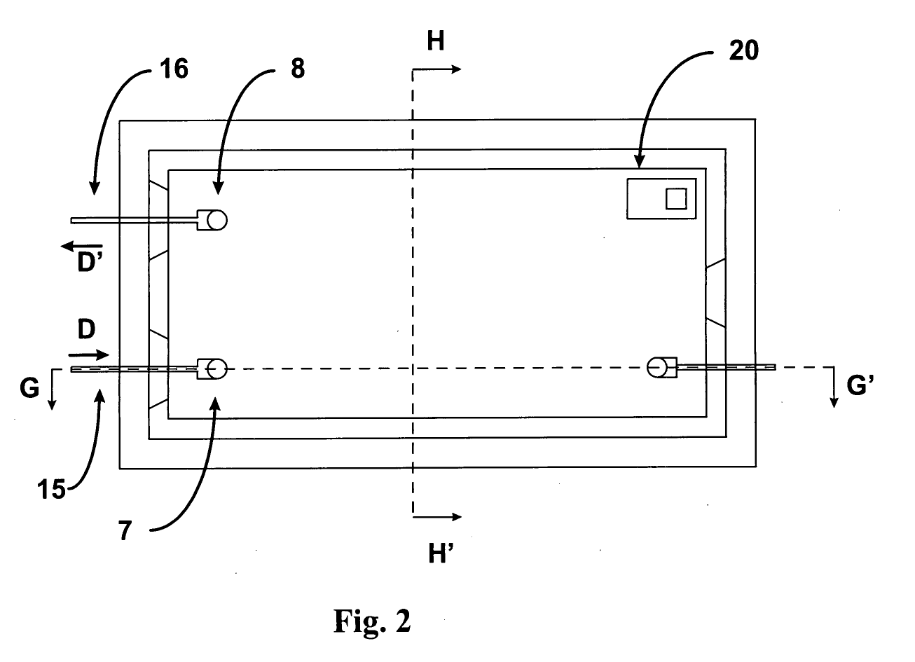

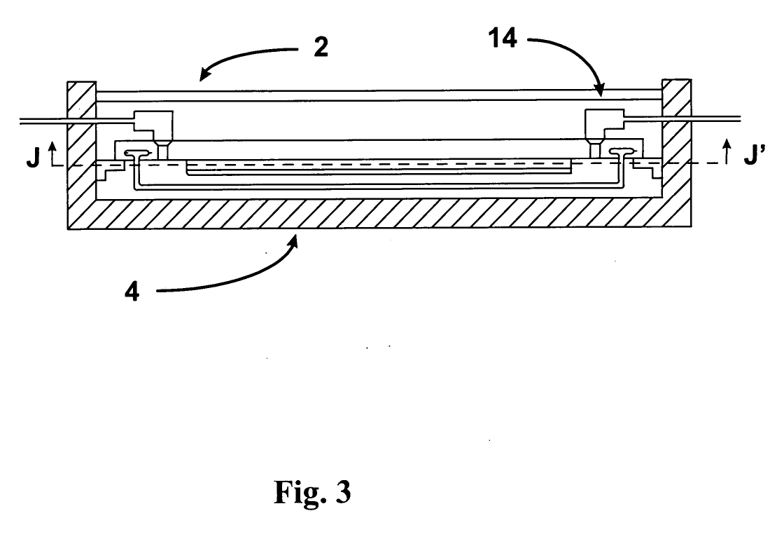

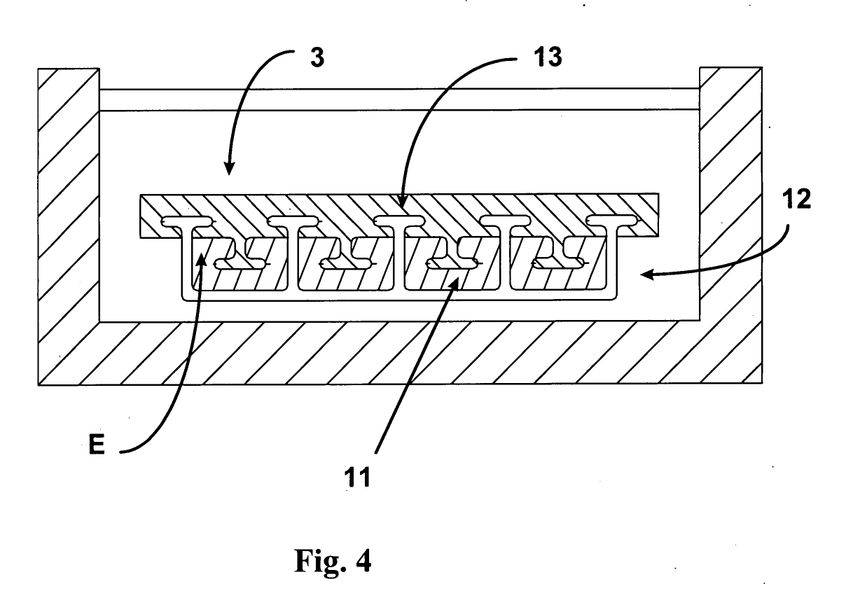

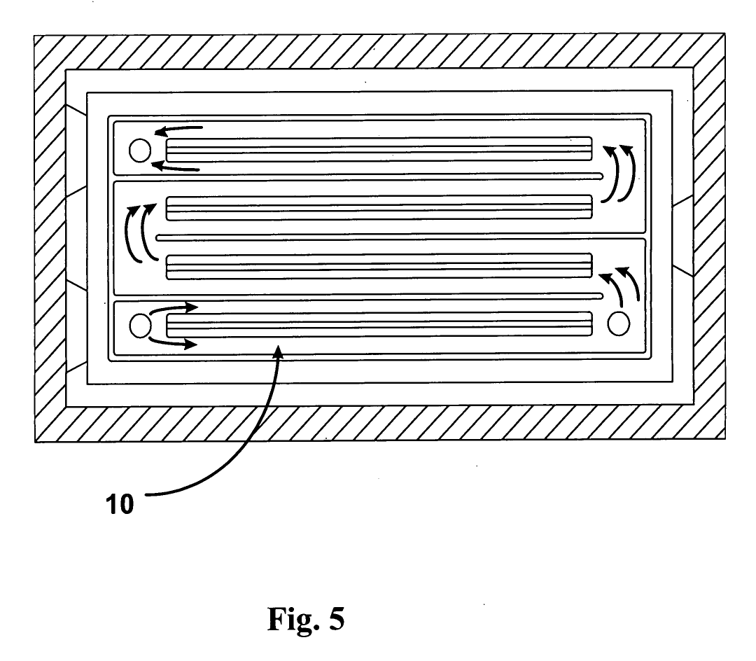

Solar radiation A, B, C (FIG. 1) impinges on solar water heating apparatus 1 and is absorbed. Efficient absorption of the solar radiation and retention of the heat obtained from said absorption is obtain through several elements. Antireflective coating of glass 2 (FIG. 3) reduced the reflection of the solar radiation, black textured surface of the primary solar radiation absorbing surface 3 (FIG. 4) and thermally insulated box 4 (FIG. 3). Water pumped from water heating system water pump 7 (FIG. 1) enters the solar water heating apparatus at water pipe D (FIG. 2) and travels through water connector 7 into water channels 10 (FIG. 5). The water E displaces water already in the water channels 10 formed onto the primary solar radiation absorbing surface 3 (FIG. 4). Water displaced travels through channels 10 (FIG. 5) and is forced out of the channels into water connector 8 and into water pipe D′ returning to water heating system (FIG. 1).

Features of a preferred embodiment of the water heating apparatus are herewith elucidated to. The material preferred to the primary heat absorbing surface 3 is black anodized aluminum which is textured to present a dull black finish 1 to the impinging solar radiation A, B, C. The textured finish may be created by sand blasting or other mechanical means as those skill in the art may employ. Anodization creates a non-reactive durable surface which is preferred for non-interaction with water and has a high thermal conductivity to transfer heat to water E. It is also readily available and relatively low cost to obtain and manufacture. To improve thermal conductivity to the water E, fin structures 11 (FIG. 4) will protrude into the water channels 10. The fin structures would be formed prior to the anodization process to also be non-reactive to water. The channel structures 10 in a preferred embodiment would be constructed of injection molded silicone. Silicone is a moldable material which is also non-reactive and durable. Silicone molded material would form a asymmetric structure with respect to the primary solar radiation absorbing surface 3. Although other materials are considered as those skilled in the art may employ, the material which is used is specifically design to stretch to withstand repeated cycles of water freezing without damage. Surface preparation of the solar radiation and heat transfer surface 3, in the preferred embodiment would have channels formed into the surface 13 (FIG. 4) to present a durable seal to the water pressure within the system. Surface treatment with a texture will also improve adhesion of the silicone to the anodized aluminum. Water fixtures 7 and 8 may be directly threaded into the surface of primary heat absorbing surface in addition to a pressure relief valve 14 (FIG. 3). The pressure relief valve would prevent damage to the solar water heating apparatus by releasing steam upon an over heating condition. Water pipes 15 and 16 exposed to adverse freezing temperature would be insulated and formed using flexible pipe. Silicone hose is considered in a preferred embodiment to withstand freezing and heating cycles. Status of the water heating apparatus is gathered by a remote electronic module 20 (FIG. 2). Information is transferred to the system controller 30 (FIG. 1). The module may use a solar panel and battery charging system to power the module. Status information such as temperature, pressure, solar radiation conditions, and water flow may be transferred to the system controller 30, to facilitate the interaction of the solar water heating apparatus within the system. The connection may be wired or a wireless connection.

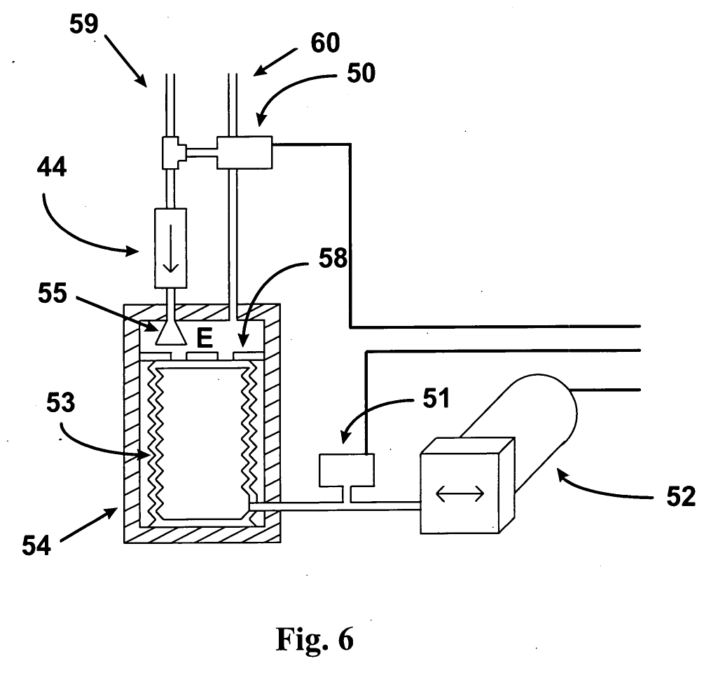

An optional auxiliary tank 45 (FIG. 1) is shown in cross section 57 (FIG. 6). The auxiliary tank 45 interacts with the overall system under control of the system controller 30. The auxiliary tank can be used to store a variable volume of water which can be heated by the solar water heating apparatus 1 within the system. The auxiliary water tank uses a reversible fluid or air pump, 52 (FIG. 6) connected to an internal expandable bladder 53 (FIG. 6). The expandable bladder 53 can change its volume, displacing water contained within the auxiliary tank. When not in use, the bladder would be expanded to it maximum volume until it contacts a perforated stop 58 (FIG. 6). When the bladder hits the perforated stop, additional air pumped into the bladder would results in increased pressure in the bladder. A pressure transducer 51 connected to the system controller would sense this condition. Under conditions that the system controller determines by algorithm, it is desired to increase the total volume of hot water, the bi-directional air pump 52 would decrease the pressure in the bladder 53. As fresh cold water is drawn into the system from the cold water pipe 59 (FIG. 6), the bladder pressure becomes equal to the inlet water pressure in the system. Sequentially, the volume of water in the auxiliary tank can be increased respectively by the reduction of volume of the bladder 53 in the auxiliary tank. When the pressure in the bladder is allowed to reach atmospheric pressure present at the air pump, the bladder has reached the minimum volume and the water contained within the auxiliary tank has reached it maximum volume. Pressure transducer 50 senses the water pressure of the inlet water system. Reduction of the volume of water contained within the auxiliary tank 45 is created by increasing the pressure of the bladder 53 above the pressure sensed by the pressure transducer 50. Air would be pumped by the air pump 52 until the pressure at bladder pressure transducer 51 is higher than the inlet water pressure 50. This differential pressure would close the check valve 44. As water is used within the water system, the bladder 53 would expand until the pressure of the bladder is substantially the same as the water inlet pressure. This condition would be sense by the pressure transducer 51 and thereby again increase the pressure in the bladder 53 until a superior pressure in the bladder is reached or the threshold pressure is reached indicating the bladder has reached its maximum volume by contacting the perforated stop 58. Other elements contained in a preferred embodiment would be a heavily insulated tank 54 (FIG. 6) to reduce thermal loss, a water diffuser 55 to intermix water within the auxiliary tank with water entering the tank during volume changes. In a preferred embodiment, the internal water tank would be constructed of food grade polyethylene with a bladder made of silicone and any various insulation material that those skilled in the art may employ.

The system controller 30, is a programmable device controlling the overall system. Information and status of the solar water heating apparatus 1, is obtain for the remote module 20. When indications are such that no supplemental heat may be provided to the primary water heating device 40 (FIG. 1) the system is largely inactive. In this case, as hot water is drawn from primary water heating device, the system water flow is created at Q. Displacement of water throughout the system sequentially from S, N, M, and L whereas the used water is displaced from the cold water supply R. The primary water heating device 40 may employ any readily available energy source to insure a continuous supply of hot water is available irrespectively of the environmental conditions. This average temperature condition of water contained within the primary water heating device 40 is programmed into the system controller. When conditions exist such that the temperature of the solar water heating apparatus 1 is above this temperature, excess heat may be transferred to the water tank of the primary water heating device. At this condition, the system controller would turn on water pump 7 pulling water from the primary water heating device 40 from O through the pump 7 into D and out D′. Water exiting D′ has been heated by the solar water heating apparatus as previously described. Water hotter than the primary system continues to flow to P and L through the auxiliary tank 45, to M and back into the primary water heating device 40. As the water flows, the temperature of the solar water heating apparatus 1 would drop. When the lower temperature sensed by the remote module 20 becomes below a preset value of the primary water heating device, the pump 7 is turned off. This cycle initiated by the system controller continues to gradually increasing the water temperature of the primary water heating device as long as conditions are favorable for supplemental hot water from the solar water heating apparatus. At anytime, a user may draw hot water from point Q which is replenished by displacement from cold water source R. A check valve 43 (FIG. 1) is placed inline with the cold water source after R to prevent back flow from the solar water heating apparatus. If conditions continue to be favorable water contained within the primary water heating device 40 would reach a maximum desired temperature. At this point the system controller would dynamically change the volume of the auxiliary tank by changing the pressure within the bladder 53 as previously described. This change in pressure would draw more cold water from the supply R through the path L and into the auxiliary tank. The cycle of heating and re-circulating water from the solar water heating apparatus 1 would continue again while conditions are favorable until the maximum desired temperature is reached. As previously described, once the auxiliary tank draws in a larger volume of water, the bladder is over pressurized above the cold water inlet pressure to turn off check valve 44, thus preventing additional cold water from entering the system. This thereby results in hot water usage by the user Q drawing from the primary and auxiliary hot water supply alone. As the hot water is used, the pressure in the hot water system, increased by the bladder pressure, drops to near the cold water inlet pressure, at which point in time the pressure is again controlled by the system controller and the pressure is increased within the bladder thus expanding and displacing used water. As previously described, the auxiliary tank volume of hot water would be adjusted depending on environmental conditions sensed at the remote module 20 connected to the system controller 30. Finally, returning back to an inactive state as solar radiation conditions change with time.

The solar water heating apparatus 1 is interconnected with the system with a pump 7 with an integral shut off valve and check valve 42 such that the primary water heating device 40 would remain in operation if the solar water heating apparatus fails. The system controller 30 may have a variety of status and panel displays and may be connected to communication systems for user interaction and maintenance.

The invention claimed is:

1. A method of manufacture of a solar heating apparatus whereby surfaces deform expressly to allow for the volume change of contained material with a change in the physical phase of said material.

2. A solar water heating apparatus whereby a pressure relief valve is included to allow for a physical change in phase of contained material.

3. A method of manufacture of a solar heating apparatus whereby heat transfer of a radiation absorbing surface is improved by elements of the heat absorbing surface to protrude into the volume of material to be heated.

4. A method of manufacture according to claim 3 wherein the primary solar radiation absorbing surface is textured to reduce reflection.

5. A method of manufacture according to claim 3 wherein the primary solar radiation absorbing surface is machined to present a durable seal for connection to a mold.

6. A vessel which can modify the internal volume of a material by displacement of another material separated by a barrier which can limit the volume of one material and allow one material to penetrate the barrier thus changing the contained volume of both materials.

7. A vessel according to claim 6 whereby the pressure presented to the inlet and outlet may be changed by addition of material into compartment separated by a barrier to another material.
